(19) United States
(12) Patent Application Publication
(10) Pub. No.: US 2004/0036973 A1
(43) Pub. Date: Feb. 26, 2004

(54) Multi-layer interference filter having colored reflectance and substantially uniform transmittance and methods of manufacturing the same

(76) Inventors: Giuseppe Iori, Reggio Emilia (IT); Graziano Marusi, Parma (IT); Federico Menta, Parma (IT); Gian Giuseppe Giani, Parma (IT)

Correspondence Address: Steven B. Pokotilow, Stroock & Stroock & Lavan LLP, 180 Maiden Lane, New York, NY, 10038, US

(21) Appl. No.: 10/449,956

(22) Filed: May 30, 2003

Related U.S. Application Data
(60) Provisional application No. 60/385,396, filed on Jun. 1, 2002.

(51) Int. Cl. G02B 1/10

(52) U.S. Cl. 359/581

(57) ABSTRACT

The present invention is concerned with a new family of optical element for use in eyeglasses, visors, masks and screens which produce a new chromatic effect through a vacuum deposition of two or plus layers of dielectric substances and methods of manufacturing the same. These new filters combine some colored reflection on the outer surface with a uniform transmission looking through the lens so complying the European Standard in terms of luminous transmittance uniformity.

### CROSS-REFERENCE TO RELATED APPLICATIONS

This application claims the benefit of U.S. Provisional Application No. 60/385,396, filed Jun. 1, 2002.

### FIELD OF THE INVENTION

The present invention relates to optical-quality multi-layer interference films, and, in particular, to optical-quality multi-layer interference films for use in eyeglasses, sunglasses, visors, masks, screens, and the like, and methods of manufacturing the same.

### BACKGROUND OF THE INVENTION

High vacuum vapor deposition is used for the production of thin film layers used in many industrial applications. In the optics field, sophisticated coating designs comprising up to 100 single layers are employed in the production of sophisticated multi-layer interference filters. Using the same technique, antireflection coatings can also be applied onto prescription eyewear and high performance sunglasses.

Stacks are formed by alternating layers of high and low refractive index materials with specific optical thicknesses. With a proper choice of evaporants, film thickness, and number of layers, it is possible to design numerous types of optical thin films based on interference that meet precise performance demands such as color reflected and degree of reflection. Evaporants are metals, alloys and inorganic compounds generally named “dielectrics”. Metals and alloys are “absorbing materials” that only in a very low thickness (few nanometers) are “semireflective”. Dielectrics are completely transparent with an individual refractive index divided in low index and high index.

A primary object of the present invention is to provide an optical-quality multi-layer filter exhibiting some color reflection on the outer surface while maintaining a substantially uniform transmittance looking through the filter, and to provide methods of manufacturing such filters. In particular, it is an object of the present invention to provide lenses and methods of manufacturing lenses with a multi-layer coating with some color reflection on the outer surface while maintaining a transmission uniformity that complies with the transmittance uniformity of the European Standard EN 1836.

### SUMMARY OF THE INVENTION

The present invention relates to a new family of optical elements for use in eyeglasses, visors, masks and screens which produce a new chromatic effect through a vacuum deposition of two or more layers of dielectric substances and methods of manufacturing the same. These new filters combine some colored reflection on the outer surface at the same time permitting a substantially uniform transmission looking through the lens, which complies with the European Standard for luminous transmittance uniformity.

To obtain the reflection together with a substantially uniform transmission, the present invention comprises a stack of layers with a Transmittance curve, defined below, of minimal slope in the region of maximum eye sensitivity (e.g., 500-600 nm). Generally, in accordance with the present invention, a lens exhibiting the beneficial properties of the present invention can be obtained by providing a stack of preferably between 2 and 8 layers of dielectric films, generating Reflectance versus wavelength and Transmittance versus wavelength curves (Reflectance and Transmittance curves), having lower slopes in the spectrum region where the human eye is more sensitive (500 to 600 nm).

Other objects and features of the present invention will become apparent from the following detailed description, considered in conjunction with the accompanying drawing figures. It is to be understood, however, that the drawings are designed solely for the purpose of illustration and not as a definition of the limits of the invention, for which reference should be made to the appended claims.

### BRIEF DESCRIPTION OF THE DRAWINGS

In the drawing figures, which are not to scale, and which are merely illustrative:

FIG. 1 shows a base 6 plastic multi-layer lens coated with multilayer dielectric films and showing the thickness in the center higher than at the edge;

FIG. 2 shows a base 8 plastic multi-layer lens coated with multilayer dielectric films and showing the thickness in the center higher than at the edge; and

FIG. 3 shows the geometry of both base 6 and base 8 lenses and the consequent angle of deposition.

### DETAILED DESCRIPTION OF THE PRESENTLY PREFERRED EMBODIMENTS

The present invention relates to a new family of optical elements for use in eyeglasses, visors, masks, screens and the like which produce a new chromatic effect through a vacuum deposition of two or more layers of dielectric substances. These new filters combine a colored reflection on the outer surface while at the same time permitting a substantially uniform transmission looking through the lens, thereby complying with the European Standard EN 1836 in terms of luminous transmittance uniformity, the method of manufacturing such lenses, as well as the lenses themselves, satisfy a long felt need in the art.

It is well known that an expert in the art of vacuum deposition can obtain on the outer surface of a lens, a variety of chromatic reflections by alternating low and high refractive index layers: from gold to purple, to blue and green. This technique can be applied on low curvature base lenses (base 4 to 6) and the transmittance on the back of the lens is uniform enough to comply with the European Standard EN 1836 (4.1.2.1 Uniformity of Luminous Transmittance) which requires a variation of transmission less than 10% in a circle 40 mm wide around the center. In contrast, Applicants have discovered that when applying the same technique to a high curvature base lens (base 8 and 9) the transmission uniformity on the back of the lens does not comply with the EN 1836 standard.

Applicants have determined that the loss of transmittance uniformity is mainly related to the surface curvature of the lens. In the case of base 8 and base 9 lenses, the curvature is high (base 8: curve radius 65.3 mm; base 9: curve radius 58 mm). Because of the high curvature, the distance from the evaporation source to the lens center is lower than from the source to the edge, and thereby it changes the incident angle of the evaporated material on the curved surface. The resulting layer thickness is greater in the center and lower at the edge which generates a different stack composition in the center than at the edge of the lens. As a result, the reflection is not even and the transmittance looking through the lens does not comply with the transmission uniformity requisites of the European Standard EN 1836.

Examples of commercially available multi-layered coatings on sunglass lenses are as follows:

Blue commercially available multi-layer coating:

| | | Physical |
|---|---|---|
| Layer # | Material | Thickness (nm) |
| | Substrate | |
| 1 | TiO₂ | 42 |
| 2 | SiO₂ | 80 |
| 3 | TiO₂ | 51 |
| 4 | SiO₂ | 80 |
| 5 | TiO₂ | 45 |
| 6 | SiO₂ | 80 |
| 7 | TiO₂ | 114 |
| 8 | SiO₂ | 80 |
| | Air | |

Orange commercially available multi-layer coating:

| | | Physical |
|---|---|---|
| Layer # | Material | Thickness (nm) |
| | Substrate | |
| 1 | TiO₂ | 82.77 |
| 2 | SiO₂ | 141.39 |
| 3 | TiO₂ | 63.48 |
| 4 | SiO₂ | 157.89 |
| 5 | TiO₂ | 44.57 |
| 6 | SiO₂ | 168.20 |
| 7 | TiO₂ | 208.01 |
| 8 | SiO₂ | 75.66 |
| | Air | |

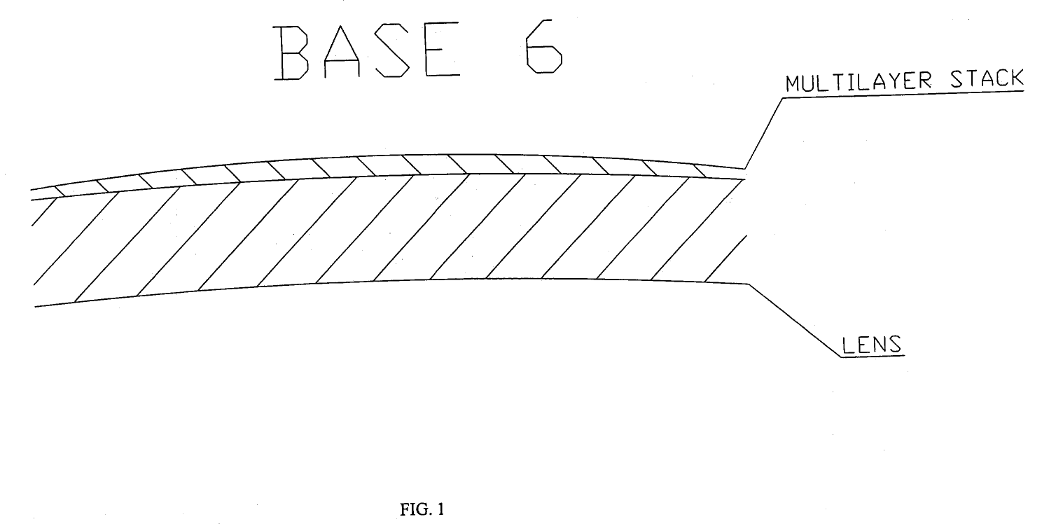

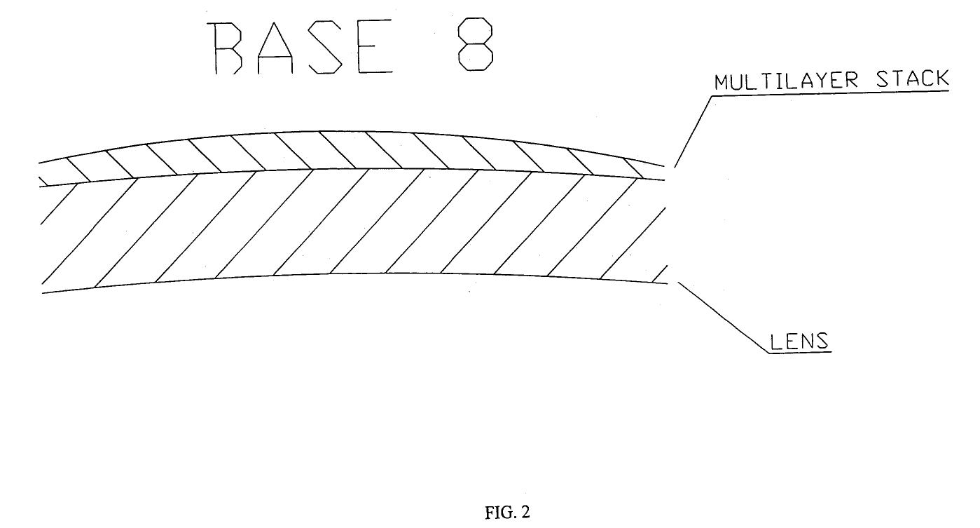

Using high vacuum deposition machines, multi-layer filters as described above are easily deposited on plates or lenses obtaining the desired chromatic effect. Applicants have determined that on curved surfaces, as for example on lenses, because of the different incident angle of the evaporated material on the curved surface, the thickness of the single layers is not uniform on the whole curved surface. In particular, as seen in FIGS. 1 and 2, the thickness changes radially going from the center to the edge of the curved surface.

Applicants determined that the thickness variation of the layers generates a variation in the Reflectance as well as in the Transmittance values (hereinafter R % and T %). R % and T %, as used herein, are the average values of Reflectance and Transmittance measured between 280 and 800 nm, being the average weighted with respect to the human eye sensitivity (in accord with the EN 1836 standard).

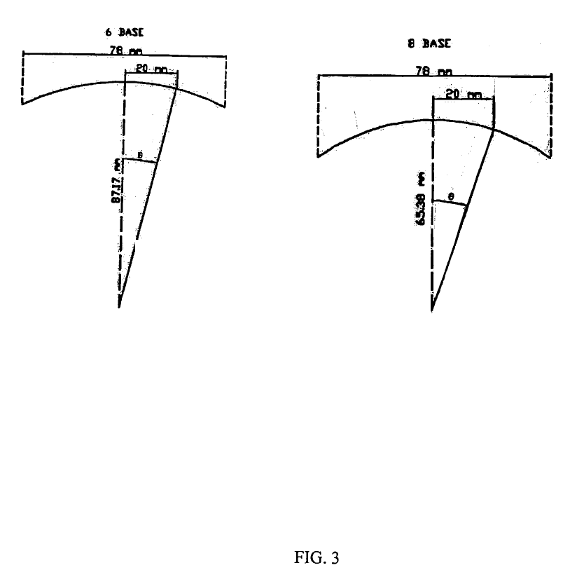

The thickness variation rate on the lens surface can be expressed in terms of R %/θ or T %/θ, where θ is an angle defined as depicted in FIG. 3. The thickness variation rate is proportional to the base curve or to the 1/curve radius. With low base curves, up to 6 base (curve radius=87.17 mm), the variation rate is limited, and in the case of lenses for sunglasses that typically have about 70 mm as maximum dimension, generally the T % uniformity is not adversely affected.

With higher base curves however, for example 8 base (curve radius=65.38), Applicants have determined that the thickness variation rate is higher and the T % difference between the geometrical center of the lens used as a reference, and a point for example 20 mm from the center, is greater than 10% or more. In this case the human eye can detect the T % difference. The EN 1836 standard states that the relative difference in the luminous transmittance value between any two points of the filter within a circle 40 mm in diameter around the reference point, shall not be greater then 10% (relative to the higher value). In FIG. 3 the geometrical centre of the lens was chosen as reference point. Thus, the commercially available multi-layer filters deposited on high base curve lenses often do not comply with EN 1836.

Applicants found that multi-layer coatings giving much more uniform T % and R % are possible if the slopes of the Reflectance and Transmittance curve are lowered, in particular in the spectrum region where the eye is more sensitive (500 to 600 nm). The Reflectance curve illustrates how much light is reflected, represented by R % on the Y-axis, according to the corresponding wavelength on the X-axis. The Transmittance curve similarly illustrates how much light is transmitted through the lens, the amount of transmittance plotted along the Y-axis, axis, when the light is of the wavelength represented on the X-axis. The slope of the Reflectance curve is the difference in reflectance divided by the difference in corresponding wavelengths. Similarly, the slope of the Transmittance curve is the difference in transmittance divided by the difference in corresponding wavelengths.

Applicants discovered that the decrease in thickness due to the spherical geometry causes a shift of the Transmittance and Reflectance curves towards the UV region of the spectrum. Applicants discovered that if the slope of the Transmittance curve in the region where the human eye is more sensitive is lower (i.e., less steep), then the T % difference caused by the shift towards the UV region is lower as well. Accordingly, the present invention is directed at lenses comprising a stack of layers that exhibit lower sloped Transmittance curve than those of the commercially available filters.

The present invention is also directed at methods of making such filters. Specifically, Applicants have determined that by using conventional means, such as commercial software for optical coating design calculation, the stack of layers to be deposited on the lens can be calculated to obtain a desired reflection by selecting high index and low index materials and the desired reflection curve.

Conventional means, such as commercially available software, can be used to calculate some preliminary stack solutions to obtain the desired curve. For example, a user can introduce the spectral curve desired and optical properties of different materials can be considered. For example, the user can determine what Reflectance or Trasmittance curve is desired. Then the user can then enter the transmission data of any ten different wavelengths of the desired Reflectance or Transmittance curve. The program can then calculate a number of layer stacks with increasing number of layers that resemble the desired curve. The user can evaluate the stacks by calculating the respective slopes of the curves in the spectral region, and, as Applicants have covered, select the stack with the most desired slope.

Generally the number of layers can be from 2 to up to more than 20. All these stacks can replicate the desired reflection curve with an increasing matching degree. To obtain some reflection, or in a preferred embodiment an intense colored reflection, while at the same time exhibiting a substantial uniformity of transmission, preferably the stack with a lower slope is selected. In a preferred embodiment, the stack with less number of layers can also be selected for economic reasons. Generally, it was determined that reflecting lenses can be obtained with a stack of layers preferably comprising between 2 and 8 layers.

Examples of two multi-layer Uniform Horizontal Transmittance (UHT) coatings in accordance with the present invention on high curvature base lenses, base 8 and 9, are as follows. The measured Reflectance and Transmittance curves are shown for each example, together with the curves of conventional stacks, the data for which is provided above, as reference.

### EXAMPLE 1

UHT Blue Multilayer Coating:

| | | Physical |
|---|---|---|
| Layer # | Material | Thickness (nm) |
| | Substrate | |
| 1 | TiO₂ | 31.50 |
| 2 | SiO₂ | 66.76 |
| 3 | TiO₂ | 38.99 |
| 4 | SiO₂ | 57.10 |
| 5 | TiO₂ | 7.35 |
| 6 | SiO₂ | 118.75 |
| | Air | |

[image]

### EXAMPLE 2

UHT Orange multi-layer coating:

| | | Physical |
|---|---|---|
| Layer # | Material | Thickness (nm) |
| | Substrate | |
| 1 | TiO₂ | 95.04 |
| 2 | SiO₂ | 118.49 |
| 3 | TiO₂ | 82.13 |
| 4 | SiO₂ | 52.02 |
| | Air | |

[image]

The stacks shown in the examples are composed of 6 and 4 layers respectively, but the same results could be achieved with 8 or more layers.

The optical properties are described in the following table, where data concerning the UHT multi-layer coating in the examples are shown in comparison with data relating the conventional multi-layer coating. L*, a* and b* are colorimetric parameters according to the international CIE System.

| Multi- | | | | | Transmittance | | |
|---|---|---|---|---|---|---|---|
| layer | Reflectance | | | | T % | T % | |
| coating | R % centre | L* | a* | b* | centre | 20 mm | DT % |
| Blue | 61.2 | 82.5 | −27.3 | −23.3 | 42.5 | 59.5 | 17 |
| UHT | 20.4 | 52.2 | −21.1 | −34.8 | 77.8 | 84.9 | 7 |
| Blue | | | | | | | |
| Orange | 10.4 | 38.6 | 39.3 | 4.27 | 89.9 | 81.9 | 8 |
| UHT | 7.1 | 32.1 | 25.3 | −2.17 | 91.6 | 88.5 | 3 |
| orange | | | | | | | |

The gain in Transmittance uniformity is evident (from 17% to 7% in case of Blue and from 8% to 3% in case of orange). As also shown, while the uniformity of transmittance of the conventional orange multi-layer coating meets the EN 1836 standard, its uniformity is greatly improved by using the technique and teachings of the present invention. Thus, improved multi-layer coatings having colored reflectance and uniform transmittance complying with the EN 1836 standard can be achieved, satisfying a long felt need in the art.

Thus, while there have been shown and described and pointed out novel features of the present invention as applied to preferred embodiments thereof, it will be understood that various omissions and substitutions and changes in the form and details of the disclosed invention may be made by those skilled in the art without departing from the spirit of the invention. It is the intention, therefore, to be limited only as indicated by the scope of the claims appended hereto.

It is also to be understood that the following claims are intended to cover all of the generic and specific features of the invention herein described and all statements of the scope of the invention which, as a matter of language, might be said to fall there between. In particular, this invention should not be construed as being limited to the dimensions, proportions or arrangements disclosed herein.

What is claimed is:

1. A method of creating a multi-layer filter for a high base curve lens having colored reflection on an outer surface thereof and having a substantially uniform transmission complying with the European Standard EN 1836 for luminous transmittance looking through the filter, comprising:
calculating stack solutions for a given number of layers of two or more dielectric materials, each of said stack solutions having a transmittance curve and a reflectance curve, wherein said transmittance curve is a transmittance versus wavelength and said reflectance curve is a reflectance versus wavelength;
selecting a stack that exhibits a lower slope transmittance curve in visible wavelength range;
depositing said selected stack on a high base curve lens.

2. The method of claim 1, wherein said preferred stack includes a plurality of layers of dielectric substances.

3. The method of claim 2, wherein said dielectric substances include TiO₂ and SiO₂.

4. The method of claim 1, wherein said step of depositing comprises vacuum depositing said stack on said lens.

5. The method of claim 1, further including the step of selecting a desired spectral curve prior to calculating stack solutions.

6. The method of claim 1, wherein said step of selecting a stack comprises selecting a preferred stack having a desired slope within a specific range of said transmittance curve.

7. The method of claim 6, further including the step of evaluating the slope of the transmittance curve of a specific range of 500-600 nm.

8. The method of claim 6, wherein said step of selecting a stack further comprises selecting the stack with the lowest slope among said transmittance curves of each of said stack solutions.

9. The method of claim 7, wherein said step of selecting a stack further comprises selecting the stack with the lowest slope among said transmittance curves of each of said stack solutions.

10. The method of claim 1, wherein said step of selecting a stack comprises selecting a preferred stack having a desired slope within a specific range of said reflectance curve.

11. The method of claim 10, further including the step of evaluating the slope of the reflectance curve of a specific range of 500-600 nm.

12. The method of claim 10, wherein said step of selecting a stack further comprises selecting the stack with the lowest slope among said reflectance curves of each of said stack solutions.

13. The method of claim 11, wherein said step of selecting a stack further comprises selecting the stack with the lowest slope among said reflectance curves of each of said stack solutions.

14. A method of claim 1, wherein said step of calculating stack solutions comprises using a software to calculate stack solutions.

15. The method of claim 14, wherein said step of using a software comprises entering transmission data of a desired spectral curve.

16. A multi-layer filter for a high base curve lens, said filter having colored reflection on an outer surface thereof and having a substantially uniform transmission looking through the filter, thereby complying with the European Standard EN 1836 in terms of luminous transmittance.

17. The filter according to claim 16, wherein said filter comprises a plurality of layers of dielectric substances.

18. A filter according to claim 16, wherein said plurality of layers are vacuum deposited.

19. A filter according to claim 16, wherein said stack includes between 2 and 8 layers of dielectric substances.

20. A filter according to claim 16, wherein said dielectric substances include TiO₂ and SiO₂.

21. A multi-layer filter having a blue colored reflection on an outer surface thereof and having a substantially uniform transmission looking through the filter, thereby complying with the European Standard EN 1836 in terms of luminous transmittance.

22. A multi-layer filter having an orange colored reflection on an outer surface thereof and having a substantially uniform transmission looking through the filter, wherein the variation of transmission is less than 8%.

23. A multi-layer filter produced by the method of claim 1, said filter having colored reflection on an outer surface thereof and having a substantially uniform transmission looking through the filter, thereby complying with the European Standard EN 1836 in terms of luminous transmittance.
